(19) United States
(12) Patent Application Publication
(10) Pub. No.: US 2025/0369522 A1
(43) Pub. Date: Dec. 4, 2025

(54) ACTUATOR AND VALVE DEVICE

(71) Applicant: FUJIKIN INCORPORATED, Osaka (JP)

(72) Inventors: Nobuo NAKAMURA, Osaka (JP); Tomohiro NAKATA, Osaka (JP); Kazunari WATANABE, Osaka (JP); Shigeru ITOI, Osaka (JP)

(21) Appl. No.: 19/223,697

(22) Filed: May 30, 2025

(30) Foreign Application Priority Data
May 31, 2024 (JP) 2024-088618

(51) Int. Cl. F16K 7/17; F16K 31/122

(52) U.S. Cl. CPC F16K 7/17; F16K 31/1221

(57) ABSTRACT

An actuator includes a casing, a drive member provided in the casing, and a sealing member having an annular shape. The drive member forms a pressure chamber together with the casing. The drive member is driven by an operating fluid flowing from outside. The sealing member is provided so as to be in contact with only one of the casing or the drive member, or in contact with neither, in a direction perpendicular to a moving direction of the drive member. The sealing member is configured to be compressed by the drive member and the casing in the moving direction as the drive member moves, thereby sealing the pressure chamber.

### CROSS REFERENCE TO RELATED APPLICATION

This present application claims priority under 35 U.S.C. § 119 to Japanese Patent Application No. 2024-088618 filed May 31, 2024, the entire content of which is incorporated herein by reference.

### TECHNICAL FIELD

The present disclosure relates to an actuator and a valve device for use in semiconductor manufacturing equipment and the like.

### BACKGROUND

In the valve device disclosed in Japanese Patent No. 7365033, which is opened and closed by an operating fluid, an O-ring is provided between a piston and a casing, in order to maintain the sealing performance of a pressure chamber.

### SUMMARY

However, the valve device disclosed in Japanese Patent No. 7365033 is configured so that the sealing performance of the O-ring is achieved by the O-ring coming into contact with the case in a direction perpendicular to the vertical direction. Accordingly, in the case where lubricating oil evaporates and the O-ring expands when the valve device is used in a high-temperature environment for a long period of time, the O-ring wears due to sliding, and the sealing performance of the O-ring deteriorates. When the sealing performance of the O-ring deteriorates, the operating fluid leaks from the pressure chamber, the actuator becomes inoperative, and the valve device thus becomes inoperative. As a result, the valve device needs to be replaced in a short period of time.

One of the objects of the present disclosure is to provide an actuator and a valve device capable of being used over a long period of time by suppressing degradation in the sealing performance of the O-ring, even when used in high-temperature environments.

A valve device according to one or more embodiments of the present disclosure includes a casing, a drive member provided in the casing, and a sealing member having an annular shape. The drive member forms a pressure chamber together with the casing. The drive member is driven by an operating fluid flowing from outside. The sealing member is provided so as to be in contact with only one of the casing or the drive member, or in contact with neither, in a direction perpendicular to a moving direction of the drive member. The sealing member is configured to be compressed by the drive member and the casing in the moving direction as the drive member moves, thereby sealing the pressure chamber.

A valve device according to one or more embodiments of the present disclosure includes a body having a flowing passage; and the actuator. The actuator is attached to the body and configured to open and close the flowing passage.

### BRIEF DESCRIPTION OF THE DRAWINGS

In the drawings:

FIG. 1 is a cross-sectional view of a valve device in a closed state according to a first embodiment;

FIG. 2 is a cross-sectional view of an actuator of the valve device in an open state according to the first embodiment;

FIG. 3 is a cross-sectional view of an actuator of a valve device in a closed state according to a second embodiment; and

FIG. 4 is a cross-sectional view of the actuator of the valve device in an open state according to the second embodiment.

### DETAILED DESCRIPTION

An actuator and a valve device according to the first embodiment in the present disclosure will be described with reference to the drawings.

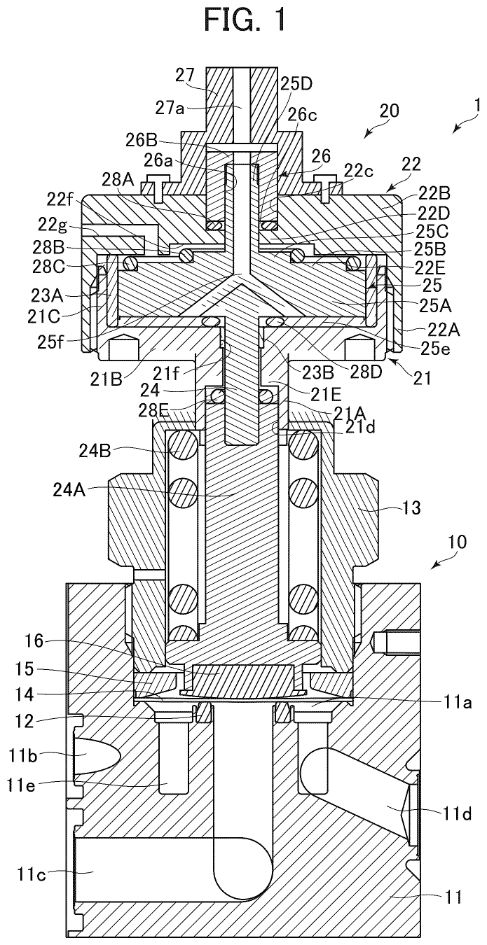

FIG. 1 shows a cross-sectional view of a valve device 1 in a closed state according to a first embodiment. The valve device 1 according to the present embodiment is a diaphragm valve.

The valve device 1 includes a body part 10 and an actuator 20. Although the valve device 1 is not limited to a specific type of valve, the valve device 1 in the present embodiment is a so-called three-way valve device. In the description below, the side of the actuator 20 in the valve device 1 is designated as the upper side, while the side of the body part 10 in the valve device 1 is designated as the lower side.

### Body Part 10

The body part 10 includes a body 11, a seat 12 which is a valve seat, a bonnet 13, a diaphragm 14, a retainer adapter 15, and a diaphragm retainer 16.

The body 11 has a substantially cube shape. The body 11 is formed with a valve chamber 11a, a first inflow passage 11b, a second inflow passage 11c, an outflow passage 11d, and an annular groove 11e. The first inflow passage 11b is divided into two passages not shown and communicates with the annular groove 11e. The seat 12, which is made of resin, has an annular shape, and is provided in the body 11 on peripheral edge of a location where the second inflow passage 11c and the annular groove 11e communicate with each other.

The bonnet 13 has a substantially cylindrical shape with a lid, and is fixed to the body 11 by threading a lower end portion thereof into the body 11 so as to cover the valve chamber 11a. The diaphragm 14, which is a valve element, is held by pinching an outer peripheral edge portion thereof between the retainer adapter 15 provided on a lower end of the bonnet 13 and a bottom surface forming the valve chamber 11a of the body 11. The fluid passages are opened or closed as the diaphragm 14 moves away from or comes into contact with (pressed against) the seat 12.

The diaphragm retainer 16 is provided on an upper side of the diaphragm 14 and is configured to be capable of pressing the center portion of the diaphragm 14. The diaphragm retainer 16 is fitted in a holder 24A to be described later. In the normal state of the valve device 1 (in the state where the actuator 20 is not operating), the diaphragm retainer 16 is pressed by a compression coil spring 24B to be described later via the holder 24A, and thereby the valve device 1 is kept in the closed state.

### Actuator 20

The actuator 20 is air-driven actuator and has a substantially cylindrical shape as a whole. The actuator 20 includes a lower casing 21, an upper casing 22, a first guide bush 23A, a second guide bush 23B, a stem 24, the holder 24A, the compression coil spring 24B, a piston 25, a pressing member 26, an air port section 27, and a first O-ring 28A, a second O-ring 28B, a third O-ring 28C, a fourth O-ring 28D, and a fifth O-ring 28E.

The lower casing 21 has a substantially stepped cylindrical shape and has a lower portion 21A, an intermediate portion 21B, and an upper portion 21C. An outer periphery of a lower end portion of the lower portion 21A is threaded into an inner periphery of a through hole of the upper end of the bonnet 13. A first through hole 21d is formed at central portions of the lower portion 21A and the intermediate portion 21B. A lower portion of the first through hole 21d is wider in diameter than an upper portion of the first through hole 21d. A first step portion 21E is provided on an inner peripheral surface of the lower portion 21A. An upper end portion of the holder 24A is inserted in the first through hole 21d. The holder 24A is supported by the lower portion 21A so as to be movable in the vertical direction. The intermediate portion 21B has a substantially disk-like shape and is formed with the first through hole 21d. An annular first recess 21f is formed on an inner peripheral surface of the intermediate portion 21B. The upper portion 21C is annular in shape and is provided to protrude upward from an outer peripheral portion of the intermediate portion 21B.

The upper casing 22 has a substantially cylindrical shape with a lid and has an outer cylinder portion 22A and an upper lid portion 22B. The outer cylinder portion 22A is threaded onto the upper portion 21C. The upper casing 22 is thereby fixed to the lower casing 21. The upper lid portion 22B is provided to cover an upper end of the outer cylinder portion 22A. A second through hole 22c is formed at a center portion of the upper lid portion 22B. The second through hole 22c has a counterbored shape. The upper lid portion 22B has a second step portion 22D. A disk-like second recess 22f is formed on a lower surface 22E of the upper lid portion 22B so as to surround the second through hole 22c. The upper lid portion 22B is formed with a leak port 22g. The leak port 22g is opened to a region outside the second recess 22f on the lower surface 22E, and to an outer peripheral surface of the upper lid portion 22B.

The first guide bush 23A and the second guide bush 23B are bearings made of resin and have hollow cylindrical shapes. The first guide bush 23A is provided inside the upper portion 21C of the lower casing 21. The second guide bush 23B is provided in the first recess 21f. The axial directions of the first guide bush 23A and the second guide bush 23B align with the axial directions of the casing (the lower casing 21 and the upper casing 22) and the bonnet 13.

The stem 24 is provided in the first through hole 21d and supported by the second guide bush 23B so as to be movable in the vertical direction. The stem 24 is configured to open or close the first inflow passage 11b, the second inflow passage 11c, and the outflow passage 11d by moving toward or away from the diaphragm 14. A lower portion of the stem 24 is threaded into an upper recess of the holder 24A. The holder 24A has a substantially columnar shape and is provided in the bonnet 13 so as to be movable in the vertical direction. The compression coil spring 24B is provided inside the bonnet 13 and constantly biases the holder 24A downward.

The piston 25 is configured integrally with the stem 24 and provided on an upper side of the stem 24. The piston 25 has a base portion 25A, a first protruding portion 25B, a second protruding portion 25C, and a third protruding portion 25D. The base portion 25A has a substantially disk-like shape, with the stem 24 integrally provided on its lower surface. The base portion 25A is supported by the first guide bush 23A so as to be movable in the vertical direction. The stem 24, the piston 25, and the holder 24A correspond to a drive member.

The first protruding portion 25B has a substantially disk-like shape and protrudes upward from an upper surface of the base portion 25A. An outer diameter of the first protruding portion 25B is configured to be larger than an inner diameter of the second recess 22f. The second protruding portion 25C has a substantially disk-like shape and protrudes upward from an upper surface of the first protruding portion 25B. The third protruding portion 25D has a substantially cylindrical shape, extends upward from an upper surface of the second protruding portion 25C, and penetrates the second through hole 22c (the upper lid portion 22B).

### A Lower Surface of the Base

portion 25A and an upper surface of the intermediate portion 21B of the lower casing 21 define a pressure chamber 25e. The piston 25 has an operating fluid inlet passage 25f extending from an upper edge thereof to the pressure chamber 25e. The operating fluid inlet passage 25f extends through the base portion 25A, the first protruding portion 25B, the second protruding portion 25C, and the third protruding portion 25D, and is divided into plural passages in the base portion 25A.

The pressing member 26 has a substantially cylindrical shape, and has a third through hole 26a in the central portion thereof. The pressing member 26 has, at the upper end portion thereof, a protrusion 26B protruding toward an inside of the third through hole 26a. In the third through hole 26a, a portion corresponding to the protrusion 26B has a smaller inner diameter than the remaining portion. The third protruding portion 25D is inserted into the portion lower than the protrusion 26B in the third through hole 26a. An upper end portion of the third protruding portion 25D is threaded into the third through hole 26a of the pressing member 26, so that the pressing member 26 is fixed to the piston 25. The pressing member 26 thus moves together with the piston 25 in the vertical direction. An upper end of the third protruding portion 25D is in contact with the protrusion 26B. A lower portion of the pressing member 26 is inserted in the second through hole 22c. A space 26c is formed between a lower surface of the pressing member 26 and an upper surface of the second step portion 22D.

The air port section 27 has a substantially stepped cylindrical shape and is fixed to an upper surface of the upper lid portion 22B. The air port section 27 has a fourth through hole 27a in the central portion thereof. In the fourth through hole 27a, a lower portion is wider in diameter than an upper portion. An upper portion of the pressing member 26 is inserted in the lower portion of the fourth through hole 27a. The pressing member 26 is supported by the upper lid portion 22B and the air port section 27 so as to be movable in the vertical direction. The fourth through hole 27a communicates with the operating fluid inlet passage 25f via the third through hole 26a. The air port section 27 is connected to an operating fluid supply source not shown, via a pipe joint and a metal piping not shown.

The first O-ring 28A is provided around the third protruding portion 25D in the space 26c. The first O-ring 28A is compressed by the pressing member 26 and the second step portion 22D when the valve device 1 is closed, thereby sealing a portion between the air port section 27 and an air chamber (a space between the lower portion of the upper casing 22 and an upper portion of the base portion 25A). The second O-ring 28B is provided on an outer periphery of the second protruding portion 25C. The second O-ring 28B is compressed by a lower surface of the second recess 22f of the upper casing 22 and an upper surface of the first protruding portion 25B when the valve device 1 is opened, thereby sealing the portion between the air port section 27 and the air chamber. The third O-ring 28C is provided on an outer periphery of the first protruding portion 25B. The third O-ring 28C is compressed by the lower surface 22E of the upper casing 22 and the upper surface of the base portion 25A when the valve device 1 is opened, thereby sealing the pressure chamber 25e.

The fourth O-ring 28D is provided around the stem 24 in the pressure chamber 25e. The fourth O-ring 28D is compressed by the lower surface of the base portion 25A and the upper surface of the intermediate portion 21B when the valve device 1 is closed, thereby sealing the pressure chamber 25e. The fifth O-ring 28E is provided around the stem 24 between an upper end of the holder 24A and the first step portion 21E. The fifth O-ring 28E is compressed by the upper end of the holder 24A and a lower surface of the first step portion 21E when the valve device 1 is opened, thereby sealing the pressure chamber 25e.

Each of the first O-ring 28A to the fifth O-ring 28E is provided in the casing so as to be in contact with only one of the casings (the lower casing 21 or the upper casing 22) or the piston 25, or in contact with neither of them, in a direction perpendicular to the moving direction (vertical direction) of the piston 25. In other words, each of the first O-ring 28A to the fifth O-ring 28E is not subjected to pressure by both the casing and the piston 25 at the same time in the direction perpendicular to the moving direction (vertical direction) of the piston 25. Each of the first O-ring 28A to the fifth O-ring 28E, in a compressed state, is in contact with only one of the casing or the piston 25, or in contact with neither of them. The first O-ring 28A to the fifth O-ring 28E correspond to a sealing member.

The opening and closing operation of the valve device 1 according to the present embodiment will be described next.

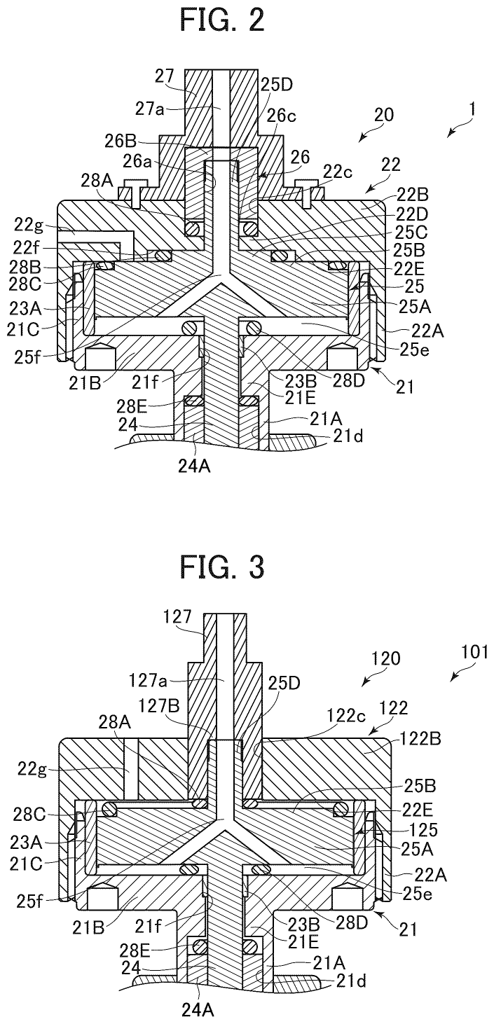

FIG. 2 is a cross-sectional view of the actuator 20 of the valve device 1 in the open state.

As shown in FIG. 1, in the valve device 1 in the closed state, no operating fluid flows into the pressure chamber 25e, the stem 24 and the piston 25 are at the bottom dead center (positioned close to the body 11), due to the biasing force of the compression coil spring 24B, and the diaphragm 14 is pressed by the diaphragm retainer 16. In other words, in the normal state (the state where a driving fluid is not supplied), the valve device 1 is in the closed state. In the valve device 1 in the closed state, the first inflow passage 11b and the outflow passage 11d communicate with each other via the annular groove 11e.

The valve device 1 is brought into a state where an operating fluid flows from the operating fluid supply source not shown to the valve device 1. The operating fluid is supplied to the valve device 1. The operating fluid flows, via the metal piping and the pipe joint not shown, through the fourth through hole 27a, the third through hole 26a, and the operating fluid inlet passage 25f, into the pressure chamber 25e. This makes the piston 25 rise against the biasing force of the compression coil spring 24B, as shown in FIG. 2. As a result, the holder 24A and the stem 24 thereby move to the top dead center (to separate from the body 11), the diaphragm retainer 16 moves upward due to the elastic force of the diaphragm 14 and the pressure of the fluid (gas), and the second inflow passage 11c and the outflow passage 11d communicate with each other via the annular groove 11e, and thereby the valve device 1 becomes in the open state.

In the valve device 1 in the fully closed state, the first O-ring 28A seals the portion between the air port section 27 and the air chamber, and the fourth O-ring 28D seals the pressure chamber 25e, thereby preventing leakage of the operating fluid during the operation of the valve device 1 from the fully closed state to the fully open state. In the valve device 1 in the fully open state, the second O-ring 28B seals the portion between the air port section 27 and the air chamber, thereby preventing leakage of the operating fluid from the air port section 27 to the air chamber. In the valve device 1 in the fully open state, the third O-ring 28C and the fifth O-ring 28E seal the pressure chamber 25e, thereby preventing leakage of the operating fluid from the pressure chamber 25e to the outside.

In order to shift the valve device 1 from the open state to the closed state, a three-way valve device not shown is switched to allow the operating fluid to be discharged from the actuator 20 (the pressure chamber 25e) of the valve device 1 to the outside. The operating fluid in the pressure chamber 25e is discharged to the outside through the operating fluid inlet passage 25f. As a result, the stem 24 and the piston 25 move to the bottom dead center due to the biasing force of the compression coil spring 24B, and thereby the valve device 1 becomes in the closed state (FIG. 1).

In the actuator 20 described above, each of the first O-ring 28A to the fifth O-ring 28E is provided in the casing so as to be in contact with only one of the casing (the lower casing 21 or the upper casing 22) or the drive member, or in contact with neither of them, in a direction perpendicular to the moving direction of the drive member (the stem 24, the piston 25, and the holder 24A), and is compressed by the drive member and the casing in the moving direction as the drive member moves, thereby sealing the pressure chamber 25e. As described above, each of the first O-ring 28A to the fifth O-ring 28E is only subjected to compression, without sliding against other members such as the casing. Even when the first O-ring 28A to the fifth O-ring 28E are used for a long period of time in a high-temperature environment, the wear caused by sliding of the first O-ring 28A to the fifth O-ring 28E can be suppressed, thereby preventing the deterioration in the sealing performance of the first O-ring 28A to the fifth O-ring 28E. Accordingly, the leak of the operating fluid from the pressure chamber 25e is prevented. Moreover, the service life of the valve device 1 for use in a high-temperature environment can be prolonged.

The drive member is supported by the first guide bush 23A and the second guide bush 23B so as to be movable in the moving direction, and it is possible to align the axis of the casing and the axis of the drive member with each other. The first O-ring 28A to the third O-ring 28C are provided on the upper surface side of the piston 25, while the fourth O-ring 28D and the fifth O-ring 28E are provided on the lower surface side of the piston 25. The leakage of the operating fluid from the pressure chamber 25e to the outside during the operation of the valve device 1 from the fully closed state to the fully open state. Moreover, the service life of the valve device 1 for use in a high-temperature environment can be prolonged.

The actuator and the valve device according to the second embodiment of the present disclosure will be described next with reference to the drawings.

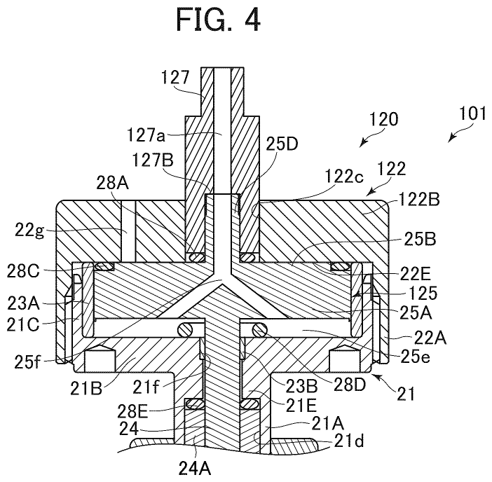

FIG. 3 is a cross-sectional view of an actuator 120 of a valve device 101 in a closed state according to the second embodiment. FIG. 4 is a cross-sectional view of the actuator 120 of the valve device 101 in an open state according to the second embodiment. The same members as those in the actuator 20 according to the first embodiment are denoted by the same reference signs, and the descriptions thereof are omitted.

The actuator 120 according to the present embodiment does not have the pressing member 26 of the first embodiment, and an air port section 127 is threaded onto the third protruding portion 25D of a piston 125. A second through hole 122c formed in an upper lid portion 122B of an upper casing 122 has a columnar shape and is not counterbored. The piston 125 does not have the second protruding portion 25C of the first embodiment, and the third protruding portion 25D is provided on the first protruding portion 25B. The air port section 127 has a substantially stepped cylindrical shape and has a fourth through hole 127a, and the third protruding portion 25D is inserted in a wider portion of the fourth through hole 127a. The upper end portion of the third protruding portion 25D is threaded into the fourth through hole 127a, and thereby the air port section 127 is fixed to the piston 125. The air port section 127 thus moves with the piston 125 in the vertical direction. The upper end of the third protruding portion 25D is in contact with a third step portion 127B. A lower portion of the air port section 127 is inserted in the second through hole 122c.

In the present embodiment, the actuator 120 does not have the second O-ring 28B of the first embodiment, and the sealing member includes the first O-ring 28A, and the third O-ring 28C to the fifth O-ring 28E. As shown in FIG. 3 and FIG. 4, in both the fully open state and the fully closed state of the valve device 101, the first O-ring 28A is constantly compressed by the lower end of the air port section 127 and the upper surface of the first protruding portion 25B. The first O-ring 28A seals the portion between the air port section 127 and the air chamber.

The actuator 120 according to the present embodiment can also exerts the same effects as those of the actuator 20 according to the first embodiment. Moreover, the actuator 120 may operate with a smaller number of O-rings.

The present disclosure is not limited to the above-described embodiments. A person skilled in the art may make various additions and changes within the scope of the present disclosure.

For example, the drive member is supported by the first guide bush 23A and the second guide bush 23B in the embodiments described above. However, instead of providing the first guide bush 23A and the second guide bush 23B, an inner peripheral surface of the casing may be coated with a paint having excellent sliding properties, so that the drive member may be supported by the inner peripheral surface of the casing. Although both the first guide bush 23A and the second guide bush 23B are provided in the embodiments described above, only one of them may be provided. The intermediate portion 21B of the lower casing 21 may have a recess on the upper surface thereof, and the fourth O-ring 28D may be provided in the recess. In the embodiments described above, each of the first O-ring 28A to the fifth O-ring 28E is provided in the casing so as to be in contact with only one of the casing or the drive member, or in contact with neither of them, in a direction perpendicular to the moving direction of the drive member. Alternatively, at least one of the first O-ring 28A to the fifth O-ring 28E may be provided in the casing so as to be in contact with only one of the casing or the drive member, or in contact with neither of them, in a direction perpendicular to the moving direction of the drive member.

What is claimed is:

1. An actuator comprising:
a casing;
a drive member provided in the casing, the drive member forming a pressure chamber together with the casing, the drive member being driven by an operating fluid flowing from outside; and
a sealing member having an annular shape, the sealing member being provided to be in contact with only one of the casing or the drive member, or in contact with neither, in a direction perpendicular to a moving direction of the drive member, the sealing member being configured to be compressed by the drive member and the casing in the moving direction as the drive member moves, thereby sealing the pressure chamber.

2. The actuator according to claim 1, the actuator further comprising a guide bush supported in the casing, the guide bush supporting the drive member to be movable in the moving direction.

3. The actuator according to claim 1, wherein
the drive member has a piston, and
the sealing member has a plurality of sealing members, some of the plurality of the sealing members being provided on an upper surface side of the piston, and a reminder of the plurality of the sealing members being provided on a lower surface side of the piston.

4. A valve device comprising:
a body having a flowing passage; and
the actuator according to claim 1, the actuator being attached to the body and configured to open and close the flowing passage.
